(19) United States
(12) Patent Application Publication
(10) Pub. No.: US 2016/0249668 A1
(43) Pub. Date: Sep. 1, 2016

(54) HYDROGEN-CONTAINING DRINK THAT CONTAINS FUNCTIONAL INGREDIENT

(71) Applicant: SHEFCO CO., LTD., Tokyo (JP)

(72) Inventor: Junichi IGARASHI, Kanuma-shi (JP)

(73) Assignee: SHEFCO CO., LTD., Tokyo (JP)

(21) Appl. No.: 14/909,833

(22) PCT Filed: Aug. 9, 2013
(86) PCT No.: PCT/JP2013/071682

§ 371 Date: May 9, 2016

(51) Int. Cl. A23L 2/54; A23L 2/52; A23L 2/60; A23L 2/56; A23F 3/16; A23L 2/02

(52) U.S. Cl. CPC A23L 2/54; A23F 3/163; A23L 2/02; A23L 2/60; A23L 2/56; A23L 2/52; A23V 2002/00

(57) ABSTRACT

A hydrogen-containing drink containing a functional ingredient such as tea and hydrogen water, which maintains a high dissolved hydrogen concentration. A hydrogen-containing drink wherein at least one functional ingredient selected from the group consisting of teas; fruits, vegetables, and plants; sugars and sweeteners; polyphenols; vitamins and coenzymes; amino acids and proteins; oxidoreductases; citric acids; and yeast extracts and polydextroses is blended in hydrogen water, the hydrogen-containing drink being prepared by: degassing water as a raw material, dissolving hydrogen gas in the degassed water through a gas-permeable hollow fiber membrane so as to produce hydrogen water, and dissolving or mixing the functional ingredient in the produced hydrogen water, or dissolving or mixing the functional ingredient in water as a raw material, degassing the obtained solution or mixture, and dissolving hydrogen gas in the degassed solution or mixture through a gas-permeable hollow fiber membrane.

### TECHNICAL FIELD

The present invention relates to a hydrogen-containing drink that contains a functional ingredient.

### BACKGROUND ART

In recent years, hydrogen-dissolved water (also simply called hydrogen water) in which hydrogen gas is dissolved in (ultra) pure water has been used for washing semiconductor silicon substrates, liquid crystal glass substrates, and the like, and is considered to have a suppressive effect on metal oxidation and spoilage of foods because of its high reductivity. Furthermore, an application of hydrogen-dissolved water to drinking water has been drawing attention because such water may improve various health disorders.

Examples of a process for producing the hydrogen-dissolved water for drinking include a process of dissolving, in raw water, hydrogen gas from a gas cylinder or hydrogen gas generated by water electrolysis. However, when hydrogen gas is simply supplied into raw water at room temperature under atmospheric pressure, the dissolved hydrogen concentration is far below from the saturated hydrogen concentration because nitrogen gas, oxygen gas, and the like dissolved in the raw water interfere with the dissolution of the hydrogen gas.

On this account, for example, there is proposed a process in which a pressure container from which air is removed is filled with hydrogen gas, and raw water is showered in the pressure container to come in contact with the hydrogen gas while keeping the pressure of hydrogen gas at 2 to 10 atmospheres in the pressure container so as to efficiently dissolve the hydrogen gas (Patent Document 1).

Alternatively, there is proposed a process in which hydrogen gas is caused to jet into water at high pressure to generate ultrafine bubbles (what is called “nanobubbles” or “microbubbles”), which are then dissolved in the water (Patent Document 2).

With attention focused on high reductivity of drinks in which hydrogen gas is dissolved, such as the hydrogen water described above, various proposals are also offered for drinks with a low oxidation-reduction potential obtained by dissolving hydrogen in tea, coffee, soft drinks, or vegetable juice, for example (Patent Documents 3 to 5).

For hydrogen-dissolved drinks, reducing a loss of dissolved hydrogen and maintaining high reductivity from manufacturing to actual drinking are important, and thus it is proposed that an antioxidant substance (reducing substance) is added so as to improve the effect of maintaining reductivity (Patent Documents 6 and 7).

### PRIOR ART DOCUMENTS

### Patent Documents

Patent Document 1: Japanese Patent No. 3606466

Patent Document 2: Japanese Patent Application Publication No. 2011-230055 (JP 2011-230055 A)

Patent Document 3: Japanese Patent Application Publication No, 2004-329188 (JP 2004-329188 A)

Patent Document 4: Japanese Patent Application Publication No. 2004-344862 (JP 2004-344862 A)

Patent Document 5: Japanese Patent Application Publication No, 2005-21146 (JP 2005-21146 A)

Patent Document 6: Japanese Patent Application Publication No. 2005-296794 (JP 2005-296794 A)

Patent Document 7: International Publication WO 2008-062814 Pamphlet

### SUMMARY OF THE INVENTION

### Problem to be Solved by the Invention

Hydrogen-containing drinks conventionally proposed, however, have the problem that hydrogen gas cannot be efficiently dissolved in raw water (liquid), and that the hydrogen concentration varies depending on each lot.

Even for drinks to which an antioxidant substance (reducing substance) is added so as to maintain high reductivity, hydrogen-containing water (a hydrogen-containing drink) obtained through any of the conventional manufacturing processes has a low hydrogen concentration in itself, and thus drinks having a desired oxidation-reduction potential cannot be provided.

### Means for Solving the Problem

The inventors of the present invention have carried out an intensive study in order to solve the problems above. As a result, the inventors have found that, in a hydrogen-containing drink that contains a functional ingredient such as tea and hydrogen water, by removing remaining gas from water as a raw material and dissolving hydrogen gas in the degassed water through a gas-permeable hollow fiber membrane, the dissolved hydrogen concentration of the hydrogen water to be used is more efficiently increased so as to prepare the hydrogen-containing drink that maintains a high dissolved hydrogen concentration. The present invention has been thereby accomplished.

The present invention relates to a hydrogen-containing drink in which at least one functional ingredient selected from the group consisting of: teas; fruits, vegetables, and plants; sugars and sweeteners; polyphenols; vitamins and coenzymes; amino acids and proteins; oxidoreductases; citric acids; and yeast extracts and polydextroses is blended in hydrogen water.

The hydrogen-containing drink is prepared by degassing water as a raw material, dissolving hydrogen gas in the degassed water through a gas-permeable hollow fiber membrane so as to produce hydrogen water, and dissolving or mixing the functional ingredient in the produced hydrogen water.
Alternatively, the hydrogen-containing drink is prepared by dissolving or mixing the functional ingredient in water as a raw material, degassing the obtained solution or mixture, and dissolving hydrogen gas in the degassed solution or mixture through a gas-permeable hollow fiber membrane.

The prepared hydrogen-containing drink is more preferably sterilized and disinfected. Water as a raw material or water in which a functional ingredient is mixed or dissolved is preferably filtered and/or purified before degassed.

The hydrogen-containing drink according to the present invention preferably includes two or more of the functional ingredients.

For the functional ingredient, teas; fruits, vegetables, and plants; sugars and sweeteners; polyphenols; vitamins and coenzymes; amino acids and proteins; oxidoreductases; citric acids; and yeast extracts and polydextroses are preferably selected from the followings.

a) Teas: powder or extract of tea selected from the group consisting of green tea (Sencha, Matcha), brown rice tea, Hojicha, barley tea, black tea, oolong tea, du zhong tea, seaweed drink, pu-erh tea, Rooibos tea, sweet tea, and senna tea.
b) Fruits, vegetables, and plants: powder, juice (squeezed liquid), or extract of fruits, vegetables, and plants selected from the group consisting of apple, orange, camu camu, acai, papaya (green papaya), grapefruit, grape, lemon, peach, pineapple, mango, apricot, cherry, melon, japanese apricot, strawberry, blueberry, raspberry, blackberry, cranberry, english gooseberry, cassis (blackcurrant), hilbery, acerola, Lonicera caerulea var. emphyllocalyx, morinda C. (noni), pomegranate, seaberry, olive, tomato, carrot, broccoli, onion, celery, cucumber, asparagus, cabbage, Angelica keiskei, aloe, barley grass, mulberry, kale, beefsteak plant, wheat malt, brown seaweed, laminaria, garlic, gingembre, Acanthopanax senticosus, maca, ginseng, Sesamum indicum, soy, Coix lacryma-jobi var, ma-yuen, brown rice, Natto, Acanthopanax senticosus, Corchorus olitorius, Linum usitatissimum, brown seaweed, laminaria, ginkgo leaf, kuma bamboo grass, rose, Moringa, Peucedanum japonicum, spirulina, Fucus vesiculosus, chlorella, marigold (lutein), nigauri, maca, pseudoginseng, Pueraria mirifica, yacon, turmeric, sunchoke, agaricus, chaga mushroom, Hericium erinaceum, grifola frondosa, Ganoderma lucidum (Leyss. ex. Fr.) Karst, Fomes yucatensis, cauliflower fungus, champignon, cat's claw, garcinia cambogia, rose hip, nikko maple, devil's-claw, alexandrian senna, golden candle, bacopa monniera, giant crape-myrtle, chastetree, ashwagandha, neem, guarana, hercampure, Indian coleus, fenugreek, Handroanthus impetiginosus, Actaea racemosa, feverfew, Hoodia gor-doni, Boswellia serrata, Salacia (Kothalahimbutu), echinacea, pfaffia, saw palmetto, and Hypericum perforatum L.
c) Sugars and sweeteners: monosaccharide consisting of glucose (grape sugar), galactose, mannose, fructose (fruit sugar), ribose, allose, psicose, gulose, xylose, arabinose, lixose, idose, and talose; disaccharide consisting of maltose (fruit sugar), lactose, cellobiose, fructose, palatinose, and sucrose (cane sugar); oligosaccharide; polysaccharide consisting of chitin, chitosan, inulin, starch, cellulose, carrageenan, glycogen, pectin, dextrin, eyclodextrin, xyloglucan, gelatin, hyaluronic acid, and algin acid; natural sweetener consisting of sugar, Wasanbon, brown sugar, soft brown sugar, honey, maple syrup, molasses (syrup: sugar cane, sugar beet, for example), starch syrup, erythritol, trehalose, maltitol, palatinose, xylitol, sorbitol, licorice extract, sweetleaf, and extract of Siraitia grosvenorii; and artificial sweetener consisting of sucralose, aspartame, and acesulfame potassium.
d) Polyphenols: flavonoid selected from the group consisting of catechin, anthocyanin, tannin, Rutin, isoflavone, and Hesperidin; chlorogenic acid (phenol acid); ellagic acid; lignan; curcumin; coumarin; resveratrol; and extract of pine bark.
e) Vitamins and coenzymes: vitamin A; vitamin B group selected from the group consisting of vitamin B1, vitamin B6, vitamin B12, vitamin B2 (riboflavin), niacin (nicotinamide, vitamin B3), and folate (vitamin 9); vitamin C; vitamin D; vitamin E; ubiquinone; ubiquinol; and pyrrolo-quinoline quinone.
f) Amino acids and proteins: valine, leucine, isoleucine, alanine, phenylalanine, glycine, tyrosine, arginine, glutamine, glutamic acid, asparagine, asparagine acid, proline, serine, threonine, lecithin, cysteine, placenta, elastin, propolis, royal jelly, astaxanthin, anserine, sardine peptide, DHA, EPA, alpha-lipoic acid, L-carnitine, ornithine, nucleic acid, glucosamine, chondroitin, fucoidan, fucoxanthin, ceramide, sesamin, chia seed, lycopene, squalene, gaba, L-citrulline, and collagen.

### g) Oxidoreductases

h) Citric acids
i) Yeast extracts

### j) Polydextroses

The hydrogen-containing drink according to the present invention preferably contains the functional ingredient in the ratio of 0.001% by mass to 20% by mass relative to the total mass of the hydrogen-containing drink.

### Effects of the Invention

According to the present invention, a hydrogen-containing drink can be obtained that has no adverse effect on the human body because foods and food additives permitted by the Food Sanitation Law, for example, are used as functional ingredients, and that maintains the oxidation-reduction potential at a low value by blending these functional ingredients in hydrogen water in which hydrogen gas is dissolved at high concentration.

### MODES FOR CARRYING OUT THE INVENTION

A hydrogen-containing drink according to the present invention is a drink in which a functional ingredient selected from the group consisting of teas; fruits, vegetables, and plants; sugars and sweeteners; polyphenols; vitamins and coenzymes; amino acids and proteins; oxidoreductases, citric acids; and yeast extracts and polydextroses is blended in hydrogen water.

The details thereof will be described below.

Examples of the functional ingredient to be blended in the hydrogen-containing drink according to the present invention include the followings. Note that extracts and juice (squeezed liquid) also include forms thereof being dried and powdered.

a) Teas: powder or extract of tea selected from the group consisting of green tea (Sencha, Matcha), brown rice tea, Hojicha, barley tea, black tea, oolong tea, du zhong tea, seaweed drink, pu-erh tea, Rooibos tea, sweet tea, and senna tea.
b) Fruits, vegetables, and plants: powder, juice (squeezed liquid), or extract of fruits, vegetables, and plants selected from the group consisting of apple, orange, camu camu, acai, papaya (green papaya), grapefruit, grape, lemon, peach, pineapple, mango, apricot, cherry, melon, japanese apricot, strawberry, blueberry, raspberry, blackberry, cranberry, english gooseberry, cassis (blackcurrant), hilbery, acerola, Lonicera caerulea var. emphyllocalyx, morinda C. (noni), pomegranate, seaberry, olive, tomato, carrot, broccoli, onion, celery, cucumber, asparagus, cabbage, Angelica keiskei, aloe, barley grass, mulberry, kale, beefsteak plant, wheat malt, garlic, gingembre, ginseng, Sesamum indicum, soy, Coix lacryma-jobi var. ma-yuen, brown rice, Natto, Acanthopanax senticosus, Corchorus olitorius, Linum usitatissimum, brown seaweed, laminaria, ginkgo leaf, kuma bamboo grass, rose, Moringa, Peucedanum japonicum, spirulina, Fucus vesiculosus, chlorella, marigold (lutein), nigauri, maca, pseudoginseng, Pueraria mirifica yacon, turmeric, sunchoke, agaricus, chaga mushroom, Hericium erinaceum, grifola frondosa, Ganoderma lucidum (Leyss. ex. Fr.) Karst, Fomes yucatensis, cauliflower fungus, champignon, cat's claw, garcinia cambogia, rose hip, nikko maple, devil's-claw, alexandrian senna, golden candle, bacopa monniera, giant crape-myrtle, chastetree, ashwagandha, neem, guarana, hercampure, Indian coleus, fenugreek, Handroanthus impetiginosus, Actaea racemosa, feverfew, Hoodia gor-doni, Boswellia serrata, Salacia(Kothalahimbutu), echinacea, pfaffia, saw palmetto, and Hypericum perforatum L. c) Sugars and sweeteners: monosaccharide consisting of glucose (grape sugar), galactose, mannose, fructose (fruit sugar), ribose, allose, psicose, gulose, xylose, arabinose, lixose, idose, and talose; disaccharide consisting of maltose (fruit sugar), lactose, cellobiose, fructose, palatinose, and sucrose; oligosaccharide; polysaccharide consisting of chitin, chitosan, inulin, starch, cellulose, carrageenan, glycogen, pectin, dextrin, cyclodextrin, xyloglucan, gelatin, hyaluronic acid, and algin acid; natural sweetener consisting of sugar, Wasanbon, brown sugar, soft brown sugar, honey, maple syrup, molasses (syrup: sugar cane, sugar beet, for example), starch syrup, erythritol, trehalose, maltitol, palatinose, xylitol, sorbitol, licorice extract, sweetleaf, and extract of Siraitia grosvenorii; and artificial sweetener consisting of sucralose, aspartame, and acesulfame potassium.
d) Polyphenols: flavonoid selected from the group consisting of catechin, anthocyanin, tannin, Rutin, isoflavone, and Hesperidin; chlorogenic acid (phenol acid); ellagic acid; lignan; curcumin; coumarin; resveratrol; and extract of pine bark (enzogenol, flavangenol).
e) Vitamins and coenzymes: vitamin A; vitamin B group selected from the group consisting of vitamin B1, vitamin B6, vitamin B12, vitamin B2 (riboflavin), niacin (nicotinamide, vitamin B3), and folate (vitamin 9); vitamin C; vitamin D; vitamin E; ubiquinone; ubiquinol; and pyrrolo-quinoline quinone.
f) Amino acids and proteins: valine, leucine, isoleucine, alanine, phenylalanine, glycine, tyrosine, arginine, glutamine, glutamic acid, asparagine, asparagine acid, proline, serine, threonine, lecithin, cysteine, placenta, elastin, propolis, royal jelly, astaxanthin, anserine, sardine peptide, DHA, EPA, alpha-lipoic acid, L-carnitine, ornithine, nucleic acid, glucosamine, chondroitin, fucoidan, fucoxanthin, ceramide, sesamin, chia seed, lycopene, squalene, gaba, L-citrulline, and collagen.
g) Oxidoreductases: Superoxide dismutase
h) Citric acids
i) Yeast extracts
j) Polydextroses (number average molecular weight: approximately 1,500 to 18,000, about 1,500 or 2,000, for example)

In addition to the above, the followings can be used as functional ingredients, for example: coffee, various sports drinks, oral rehydration solution, milk, milk beverages, lactic acid bacteria beverages, soybean milk, adjusted soybean milk, and alcoholic beverages (such as wine, sake, distilled spirits, whiskies, and other hard liquors), their dry powders and extracts, and various flavors that are generally used for food.

One of these functional ingredients can be used singly, or two or more in the same group or two or more in different groups of a) to i) described above can be combined to be blended in the hydrogen-containing drink according to the present invention.

For example, when two or more of functional ingredients in different groups of a) to i) are combined, examples of combinations can include the followings. Herein, “teas” refer to powder or extract of <a) Teas>, “fruit juice” refers to powder, juice squeezed liquid), or extract of <b) Fruits, vegetables, and plants>, “sweeteners” refer to <c) Sugars and sweeteners>, “polyphenols” refer to <d) Polyphenols>, “vitamins” refer to <e) Vitamins and coenzymes>, and “amino acids” refer to <f) Amino acids and proteins>. The foregoing may include one, or two or more of functional ingredients.

Collagen+sweetener+fruit juice+flavor

Collagen+hyaluronic acid+sweetener+fruit juice+flavor

Collagen+hyaluronic acid+vitamin C+sweetener+fruit juice+flavor

Chondroitin+glucosamine+sweetener+fruit juice+flavor

Oxidoreductases (superoxide dismutase)+sweetener+fruit juice+flavor

Amino acid+sweetener+fruit juice+flavor

Vitamin+sweetener+fruit juice+flavor

Amino acid+vitamin+sweetener+fruit juice+flavor

Teas+vitamin C

Teas+polyphenols

Fruit juice+flavor

Fruit juice+sweetener+flavor

In addition to the above, various combinations, such as a combination of only teas (Sencha and Hojicha, for example), a combination of only fruit juice (only fruits such as an apple and an orange, only vegetables such as a tomato and celery, a combination of a fruit and a vegetable such as an apple and celery), may be naturally allowed.

These functional ingredients (when two or more of them are blended, this applies to the total amount thereof) can be blended in the ratio of 0.001% by mass to 20% by mass relative to the total mass of a hydrogen-containing drink, and are preferably blended in the ratio of 0.002% by mass to 10% by mass.

The hydrogen-containing drink according to the present invention is prepared by degassing water as a raw material, dissolving hydrogen gas in the degassed water through a gas-permeable hollow fiber membrane so as to produce hydrogen water, and dissolving or mixing the functional ingredient in the produced hydrogen water.

Alternatively, the hydrogen-containing drink according to the present invention is prepared by dissolving or mixing the functional ingredient in water as a raw material, degassing the obtained solution or mixture, and dissolving hydrogen gas in the degassed solution or mixture through a gas-permeable hollow fiber membrane.

Note that, by degassing liquid of a functional ingredient (for example, vegetable juice or milk) itself and dissolving hydrogen gas in the degassed liquid through a gas-permeable hollow fiber membrane, a hydrogen-containing drink can also be prepared.

The hydrogen-containing drink prepared as described above can be subjected to sterilization and disinfection that are usually performed to provide it as a drink, and can also be filtered and purified before degassed so as to remove impurities from water as a raw material or water in which a functional ingredient is mixed or dissolved,

A process for dissolving hydrogen in water as a raw material or water in which a functional ingredient is mixed or dissolved can be performed in accordance with the process disclosed by the inventors of the present invention in the prior patent application (the description of Japanese Patent Application No. 2009-123310), for example, that is a process for dissolving hydrogen through a membrane. The patent application is incorporated herein by reference in its entirety.

Specifically, the process is characterized by including (a) a purifying step, (b) a degassing step, (c) a hydrogen-dissolving step, and (d) a sterilizing step, and by continuously carrying out each of the steps in a closed system.

(a) Purifying Step

This step is a step of filtering water as a raw material with a purification device and transferring the obtained purified water to a degasser. Note that, in the present invention, this step may be a step of filtering water in which the functional ingredient is dissolved and transferring the obtained water to a degasser.

The water as a raw material is not specifically limited as long as it is supplied from a water source suited for drinking, and examples thereof include tap water (water supplied from water service provided by water utility, private water service, or small scale private water service) and groundwater.

The purification device includes an activated carbon filtration device and a membrane filtration device.

The activated carbon filtration device removes musty smell and trihalomethanes from, and dechlorinates, water as the raw material. A safe filter filtration device removes suspended substances (including activated carbon), bacteria such as E. coli, pathogenic protozoa such as Cryptosporidium, and the like.

Examples of the membrane usable for the membrane filtration device include a microfiltration membrane (MF membrane), an ultrafiltration membrane (UF membrane), a nanofiltration membrane (NF membrane), and a reverse osmosis membrane (RO membrane). The MF membrane is desirably used considering operability and residual property of mineral components that determine the taste when used for drinking. Though the NF membrane or the RO membrane may be used for the membrane permeation treatment, the mineral components dissolved in raw water, such as sodium ions and potassium ions, are also removed by such a membrane. Hence, in order to produce water suited for drinking, the need for adjusting residual ratios of these mineral components or the need for adding such components arises, which results in complicating the operation. Thus, these membranes are not preferred.

(b) Degassing Step

This step is a step of degassing the purified water supplied to the degasser and transferring the obtained degassed water to a hydrogen dissolution device.

The degasser is not specifically limited as far as it can remove dissolved gases such as an oxygen gas, a nitrogen gas, and a carbon dioxide gas, and usable examples thereof include a vacuum degasser and a degasser equipped with a module including a gas permeable membrane (degassing membrane module). The degasser equipped with a degassing membrane module is preferred because it can efficiently remove gas dissolved in a trace amount.

The degassing membrane module is partitioned into a water room and a gas room by a degassing membrane and removes gas dissolved in the water that flows through the water room by allowing the purified water to pass through the water room and by depressurizing the gas room.

The degassing membrane (hollow fiber membrane) used in the present step is not specifically limited, and examples thereof include membranes of polymer such as polypropylene, polydimethylsiloxane, a polycarbonate-polydimethylsiloxane block copolymer, a polyvinylphenol-polydimethylsiloxane-polysulfone block copolymer, poly(4-methylpentene-1-), poly(2,6-dimethylphenylene oxide), and polytetrafluoroethylene,

The present step may be carried out under heating in order to improve the degassing efficiency. For such a case, the degassed water is desirably cooled to room temperature (about 25° C.) in order to improve hydrogen-dissolving efficiency after the degassing step.

(c) Hydrogen-dissolving Step

This step is a step of dissolving hydrogen gas in the degassed water supplied to the hydrogen dissolution device and transferring the obtained hydrogen-dissolved water to a sterilizer.

As the hydrogen dissolution device, a hydrogen dissolution device equipped with a gas permeable membrane module is used because the dissolution amounts of hydrogen gas per unit time and per unit space are large and the dissolution efficiency of hydrogen gas is readily increased.

The gas permeable membrane module is partitioned into a water room and a gas room by a gas permeable membrane and dissolves hydrogen gas in the degassed water that flows through the water room by allowing the degassed water to pass through the water room and by supplying the hydrogen gas into the gas room.

Examples of the gas permeable membrane used in the present step include polymer membranes exemplified as the degassing membrane above.

The supply method of the hydrogen gas is not specifically limited, and usable examples thereof include commercially available high purity hydrogen gas in a cylinder and hydrogen gas obtained by electrolysis of water.

For supplying the hydrogen gas into the gas room in the gas permeable membrane module, the hydrogen gas pressurized at atmospheric pressure or more, for example, at a pressure of about 1.2 atmospheres to 2.0 atmospheres may be supplied in order to increase the dissolved hydrogen concentration. However, for the supply of the hydrogen gas having a pressure of more than 2.0 atmospheres, the pressure-resistance and gas tightness of various devices in the gas permeable membrane module need to be increased. Thus, the production cost is increased, and such a condition is not preferable.

(d) Sterilizing Step

This step is a sterilizing step of sterilizing the hydrogen-dissolved water supplied to the sterilizer.

The sterilizer includes an ultraviolet irradiation device and a membrane filtration device. The ultraviolet irradiation device sterilizes the hydrogen-dissolved water and the membrane filtration device removes suspended substances, bacteria, and the like again.

Also in the present step, as with the purification device above, the MF membrane filtration device is preferably used. An MF membrane having a smaller pore size than that of the MF membrane used in the purification device described above is more desirably used because it can completely remove the suspended substances and the like.

By returning part of the hydrogen water obtained in the step (d) to the degasser in the step (b) and circulating the water through the step (b) to the step (d), in particular, by temporarily stopping the supply of the purified water to the degasser during the water circulation, the hydrogen gas can be more efficiently dissolved in the degassed water to produce hydrogen water having a high hydrogen gas dissolution concentration. Specifically, the dissolved hydrogen concentration that is typically about 1.6 ppm at room temperature under atmospheric pressure can be increased to about twice the concentration.

The hydrogen water produced in this way is mixed with the functional ingredient so as to obtain the hydrogen-containing drink according to the present invention. When the functional ingredient is already dissolved in water as a raw material, the hydrogen-containing drink according to the present invention can be obtained by undergoing the step (d).

The produced hydrogen-containing drink that contains the functional ingredient is filled in a sealed container and heat-sterilized as desired.

The sealed container is not specifically limited, and examples thereof include a pouch-like container made from laminated film and the like and a metal can. A pouch-like container made from aluminum laminated film is especially preferred because it has high gas tightness to prevent hydrogen leakage. The pouch-like container may have a plastic-made spout and the like. The hydrogen-containing water is filled in a sealed container using a filling device suited for the sealed container and sealed.

The hydrogen-containing drink filled in the sealed container, which is a water product, can be heat-sterilized using a heat steam sterilizer, for example, at 85° C. to 90° C. for 20 minutes to 1 hour.

### EXAMPLES

Desirable embodiments of the present invention will be described in further detail, but the present invention is not limited thereto.

### Reference Example 1

### Stability Evaluation of Oxidation-Reduction Potential by Variations in Hydrogen Dissolving Processes

Hydrogen water was produced using the following 1) to 3) hydrogen dissolving processes, and changes with time in oxidation-reduction potentials were measured. The hydrogen dissolving processes are as follows:

1) Process for dissolving hydrogen through a membrane: The hydrogen water used for the present test can be preferably produced by the process disclosed by the inventors of the present invention in the prior patent application (the description of Japanese Patent Application No. 2009-123310).

That is, the hydrogen water was produced by (1) a purifying step of filtering and purifying water as a raw material in a purification device and transferring the purified water obtained to a degasser, (2) a degassing step of degassing the purified water supplied to the degasser and transferring the degassed water obtained to a hydrogen dissolution device, (3) a hydrogen-dissolving step of dissolving hydrogen gas in the degassed water supplied to the hydrogen dissolution device and transferring the hydrogen-dissolved water obtained to a sterilizer, and (4) a process of sterilizing the hydrogen-dissolved water supplied to the sterilizer.

2) Pressure type: Water and hydrogen gas were introduced into a can body, the inside of which was then pressurized to dissolve the hydrogen gas. Note that water was not degassed before the introduction of hydrogen gas.
3) Microbubbling process: Hydrogen gas was introduced in the form of fine bubbles into water and dissolved. Note that water was not degassed before the introduction of hydrogen gas.

Oxidation-reduction potentials were measured using the following procedure.

First, 200 mL of each hydrogen water produced by the corresponding process were measured out to prepare two samples for each process, or six samples in total (Example 1 to Example 6). The oxidation-reduction potential and the pH value of each prepared sample were measured for the first time after a lapse of two hours, and thereafter every hour. Measurements were finished once the oxidation-reduction potentials of all the six samples became plus values, and the dissolved hydrogen concentrations of all the six samples were finally measured.

Tables 1 and 2 list the obtained results.

TABLE 1

| | Process for dissolving | | | | | | | | | | | |
|---|---|---|---|---|---|---|---|---|---|---|---|---|
| | hydrogen through a | | | | | | | | | | | |
| | membrane | | | | Pressure process | | | | Microbubbling process | | | |
| | Example 1 | | Example 2 | | Example 3 | | Example 4 | | Example 5 | | Example 6 | |
| Elapsed | | ORP | | ORP | | ORP | | ORP | | ORP | | ORP |
| time | pH | (mV) | pH | (mV) | pH | (mV) | pH | (mV) | pH | (mV) | pH | (mV) |
| 2 | 6.84 | −588 | 6.87 | −585 | 7.29 | −612 | 7.29 | −613 | 6.88 | +59 | 6.91 | −571 |
| 3 | 6.85 | −586 | 6.89 | −586 | 7.36 | −611 | 7.32 | −610 | 6.92 | +173 | 6.90 | +122 |
| 4 | 6.90 | −586 | 6.93 | −583 | 7.35 | −605 | 7.36 | −606 | 6.94 | +213 | 6.95 | +199 |
| 5 | 6.93 | −577 | 6.93 | −575 | 7.42 | −590 | 7.42 | −595 | 7.02 | +236 | 6.97 | +212 |
| 6 | 6.96 | −568 | 6.97 | −561 | 7.41 | +92 | 7.44 | +115 | 7.01 | +241 | 7.00 | +240 |
| 7 | 6.98 | +76 | 7.03 | +84 | 7.39 | +88 | 7.44 | +80 | 7.04 | +228 | 7.04 | +234 |

TABLE 2

| Dissolved | | | | | | |
|---|---|---|---|---|---|---|
| hydrogen | Process for dissolving | | | | | |
| concentration | hydrogen through a membrane | | Pressure process | | Microbubbling process | |
| (ppm) | Example 1 | Example 2 | Example 3 | Example 4 | Example 5 | Example 6 |
| | 0.42 | 0.39 | 0.29 | 0.27 | 0.12 | 0.12 |

As listed in Tables 1 and 2, the hydrogen water produced using the process for dissolving hydrogen through a membrane maintained a low oxidation-reduction potential (minus value) for longer time after production and had a higher oxidation-reduction potential after a lapse of seven hours than the hydrogen water produced using the pressure process and that produced using the microbubbling process did.

### Example 1

### Production of Hydrogen-containing Drinks

Hydrogen water was produced using the hydrogen water for which the “process for dissolving hydrogen through a membrane” was used, which is described in Reference Example 1,

Of the obtained hydrogen water, 200 mL each was measured out, into which functional ingredients were put, agitated, and mixed in the respective ratios listed in Table 3 to Table 14 below so as to prepare a hydrogen-containing drink.

### Example 2

### Reductivity Evaluation of Hydrogen-Containing Drinks

After the mixing, the dissolved hydrogen concentration, the pH, and the oxidation-reduction potential were measured after the lapse of a certain time period. Table 3 to Table 14 list these numerical values as well. Note that the oxidation-reduction potential is preferably minus.

TABLE 3

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen | — | 9.2 | 0.28 | 7.03 | +44 |
| water only | | | | | |
| +Catechin | 5 mg | 9.2 | 0.41 | 6.70 | −439 |
| powder*¹⁾ | | | | | |
| +Sencha | 100 mg | 9.2 | 0.44 | 6.68 | −443 |
| powder*²⁾ | | | | | |

*¹⁾Mitsui Norin Co., Ltd., trade name: Polyphenon 70S (catechin content of 80% or higher)
*²⁾Shimizuen Co., Ltd

TABLE 4

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen | — | 23.5 | 0.03 | 6.99 | +206 |
| water only | | | | | |
| +Sencha | 50 mg | 23.5 | 0.48 | 6.45 | −547 |
| powder*²⁾ | | | | | |
| +Brown | 50 mg | 23.5 | 0.25 | 6.75 | −22 |
| rice tea | | | | | |
| powder*²⁾ | | | | | |

*²⁾Shimizuen Co., Ltd

TABLE 5

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen | — | 14.2 | 0.12 | 7.13 | +221 |
| water only | | | | | |
| +Grape | 50 mg | 14.2 | 0.33 | 6.92 | −574 |
| sugar*³⁾ | | | | | |

*³⁾San-ei Sucrochemical Co., Ltd., trade name: TDA-S

TABLE 6

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen | — | 15.0 | 0.11 | 6.94 | +205 |
| water only | | | | | |
| +Oxidore- | 20 mg | 15.0 | 0.69 | 6.81 | −590 |
| ductase*⁴⁾ | | | | | |

*⁴⁾U-Medica Inc., trade name: Mn-SOD (superoxide dismutase)

TABLE 7

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen | — | 15.0 | 0.07 | 6.99 | +249 |
| water only | | | | | |
| +Green papaya | 100 mg | 15.0 | 0.55 | 6.56 | −585 |
| extract | | | | | |
| powder*⁵⁾ | | | | | |

*⁵⁾Green Spice Seasoning Co., Ltd.

TABLE 8

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.15 | 6.93 | +201 |
| only | | | | | |
| +Red wine | 100 mg | 9.0 | 0.31 | 5.25 | −94 |
| extract*⁶⁾ | | | | | |
| +Apple extract | 100 mg | 9.0 | 0.35 | 6.10 | −147 |
| powder*⁷⁾ | | | | | |
| +Acai powder*⁸⁾ | 100 mg | 9.0 | 0.52 | 6.60 | −490 |
| +Maca powder*⁹⁾ | 100 mg | 9.0 | 0.44 | 6.69 | −427 |
| +Green tea | 100 mg | 9.0 | 0.61 | 5.61 | −511 |
| extract*¹⁰⁾ | | | | | |
| +Aloe | 100 mg | 9.0 | 0.46 | 6.64 | −295 |
| arborescens*¹¹⁾ | | | | | |
| +Isomalto- | 100 mg | 9.0 | 0.43 | 6.97 | −314 |
| oligosac- | | | | | |
| charide*¹²⁾ | | | | | |
| +Natural | 100 mg | 9.0 | 0.51 | 6.11 | −417 |
| citrus fruit | | | | | |
| extract*¹³⁾ | | | | | |
| +Fruits/ | 100 mg | 9.0 | 0.47 | 6.73 | −314 |
| vegetables | | | | | |
| extract*¹⁴⁾ | | | | | |

*⁶⁾Medience Corporation
*⁷⁾Marine Bio Co., Ltd.
*⁸⁾Sanshin Trading Co., Ltd, trade name: Dry extract acai
*⁹⁾Sanshin Trading Co., Ltd
*¹⁰⁾Bio Actives Japan Corporation, trade name: Green tea extract
*¹¹⁾Hirata Farm
*¹²⁾Showa Sangyo Co., Ltd.
*¹³⁾SCETI K.K., trade name Sinetrol WS (100% natural citrus fruit extract)
*¹⁴⁾SCETI K.K., trade name: OXXYNEA WS (100% fruits/vegetables extract)

TABLE 9

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.18 | 6.99 | +251 |
| only | | | | | |
| +Vitamin C*¹⁵⁾ | 50 mg | 9.0 | 0.36 | 3.12 | −35 |
| +Orange | 50 mg | 9.0 | 0.41 | 5.05 | −144 |
| powder*¹⁶⁾ | | | | | |
| +Grapefruit | 50 mg | 9.0 | 0.35 | 5.45 | −427 |
| powder*¹⁷⁾ | | | | | |
| +Lemon powder*¹⁸⁾ | 50 mg | 9.0 | 0.33 | 3.63 | −37 |
| +Sucralose and | 50 mg | 9.0 | 0.28 | 7.07 | −29 |
| other sweeteners*¹⁹⁾ | | | | | |
| +Erythritol*²⁰⁾ | 50 mg | 9.0 | 0.29 | 6.96 | −69 |

*¹⁵⁾MORIMURA BROS., INC.
*¹⁶⁾Yaizu Suisankagaku Industry Co., Ltd,, trade name: Orange powder No. 1 (fruit juice powder)
*¹⁷⁾Yaizu Suisankagaku Industry Co., Ltd., trade name: Grapefruit powder No. 1 (fruit juice powder)
*¹⁸⁾Soda Aromatic Co., Ltd., trade name: Lemon powder No. 1 (fruit juice powder)
*¹⁹⁾San-Ei Gen F.F.I., Inc., trade name: San Sweet SA8020 (24% sucralose, 18% acesulfame potassium, 58% food material (reduced palatinose))
*²⁰⁾Mitsubishi-Kagaku Foods Corporation

TABLE 10

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.21 | 6.95 | +220 |
| only | | | | | |
| +Enzogenol*²¹⁾ | 50 mg | 9.0 | 0.27 | 6.57 | −344 |
| +Purified citric | 50 mg | 9.0 | 0.54 | 2.41 | −412 |
| acids | | | | | |
| (anhydrous)*²²⁾ | | | | | |
| +Peach powder*²³⁾ | 50 mg | 9.0 | 0.29 | 6.46 | −83 |
| +Hesperidin*²⁴⁾ | 50 mg | 9.0 | 0.66 | 6.88 | −546 |
| +Collagen*²⁵⁾ | 50 mg | 9.0 | 0.57 | 7.02 | −538 |
| +Hyaluronic | 50 mg | 9.0 | 0.42 | 6.87 | −412 |
| acid*²⁶⁾ | | | | | |
| +Mango juice | 50 mg | 9.0 | 0.44 | 6.65 | −545 |
| powder*²⁷⁾ | | | | | |
| +L-Citrulline*²⁸⁾ | 50 mg | 9.0 | 0.28 | 6.94 | −223 |

*²¹⁾Alfresa Pharma Corporation
*²²⁾FUSO CHEMICAL CO., LTD.
*²³⁾Yaizu Suisankagaku Industry Co., Ltd., trade name: Peach powder No. 1 (fruit juice powder)
*²⁴⁾Toyo Sugar Refining Co., Ltd., trade name: αG Hesperidin PA-T
*²⁵⁾Jellice Co., Ltd., trade name: Collagen HACP-TP7
*²⁶⁾Nippon Shinyaku Co., Ltd., trade name: Hyaluronic acid 3000
*²⁷⁾KOBAYASHI PERFUMERY CO., LTD, trade name: Mango juice powder SK-89 (fruit juice powder)
*²⁸⁾KYOWA HAKKO BIO CO. LTD., trade name: Hakko Citrulline Kyowa

TABLE 11

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.12 | 6.98 | +255 |
| only | | | | | |
| +Riboflavin | 5 mg | 9.0 | 0.27 | 6.96 | −73 |
| (Vitamin B2)*²⁹⁾ | | | | | |
| +Niacin (Vitamin B | 5 mg | 9.0 | 0.27 | 7.04 | −303 |
| group)*³⁰⁾ | | | | | |
| +Riboflavin*²⁹⁾ | 5 mg | 9.0 | 0.32 | 6.96 | −366 |
| +Niacin*³⁰⁾ | 5 mg | | | | |
| +Catechin | 5 mg | 9.0 | 0.50 | 5.94 | −509 |
| powder*¹⁾ | | | | | |
| +Catechin | 5 mg | 9.0 | 0.55 | 3.01 | −351 |
| powder*¹⁾ | | | | | |
| +Vitamin C*¹⁵⁾ | 20 mg | | | | |
| +Oxidoreductase*⁴⁾ | 5 mg | 9.0 | 0.53 | 6.75 | −588 |
| +Oxidoreductase*⁴⁾ | 5 mg | 9.0 | 0.58 | 7.01 | −603 |
| +Erythritol*²⁰⁾ | 5 mg | | | | |
| +Sucralose and | 5 mg | | | | |
| other sweeteners*¹⁹⁾ | | | | | |
| +Collagen*²⁵⁾ | 20 mg | 9.0 | 0.49 | 7.36 | −606 |
| +Collagen*²⁵⁾ | 20 mg | 9.0 | 0.54 | 7.33 | −613 |
| +Erythritol*²⁰⁾ | 20 mg | | | | |
| +Sucralose and | 20 mg | | | | |
| other sweeteners*¹⁹⁾ | | | | | |
| +Collagen*²⁵⁾ | 20 mg | 9.0 | 0.55 | 6.69 | −559 |
| +Catechin | 20 mg | | | | |
| powder*¹⁾ | | | | | |

*¹⁾Mitsui Norin Co., Ltd., trade name: Polyphenon 70S (catechin content of 80% or higher)
*⁴⁾U-Medica Inc., trade name: Mn-SOD (superoxide dismutase)
*¹⁵⁾MORIMURA BROS., INC.
*¹⁹⁾San-Ei Gen F.F.I., Inc., trade name: San Sweet SA8020 (24% sucralose, 18% acesulfame potassium, 58% food material (reduced palatinose))
*²⁰⁾Mitsubishi-Kagaku Foods Corporation
*²⁵⁾Jellice Co., Ltd., trade name CollagenHACP-TP7
*²⁹⁾Daiichi Fine Chemical Co., Ltd.
*³⁰⁾DSM Nutrition Japan K.K.

TABLE 12

| | Blending | | Time | Dissolved | | Oxidation- |
|---|---|---|---|---|---|---|
| | amount of | | left | hydrogen | | reduction |
| | functional | | standing | concentra- | | potential |
| | ingredient | | (hours) | tion (ppm) | pH | (mV) |
| Hydrogen water | — | | 9.0 | 0.11 | 6.94 | +310 |
| only | | | | | | |
| +Vitamin B1*³¹⁾ | 5 | mg | 9.0 | 0.27 | 3.82 | −78 |
| +Vitamin B6*³²⁾ | 5 | mg | 9.0 | 0.41 | 3.80 | −390 |
| +Vitamin B1*³¹⁾ | 5 | mg | 9.0 | 0.52 | 3.75 | −410 |
| +Vitamin B6*³²⁾ | 5 | mg | | | | |
| +Folate*³³⁾ | 20 | mg | 9.0 | 0.45 | 5.74 | −483 |
| +Vitamin B1*³¹⁾ | 5 | mg | 9.0 | 0.57 | 3.91 | −425 |
| +Vitamin B2*³⁴⁾ | 5 | mg | | | | |
| +Vitamin B6*³²⁾ | 5 | mg | | | | |
| +Vitamin B12*³⁵⁾ | 50 | μg | | | | |
| +Folate*³³⁾ | 5 | mg | | | | |
| +Valine*³⁶⁾ | 20 | mg | 9.0 | 0.35 | 6.89 | −186 |
| +Isoleucine*³⁷⁾ | 20 | mg | 9.0 | 0.29 | 6.96 | −43 |
| +Valine*³⁶⁾ | 20 | mg | 9.0 | 0.39 | 6.85 | −486 |
| +Isoleucine*³⁷⁾ | 20 | mg | | | | |

*³¹⁾Tanabe Seiyaku Co., Ltd.
*³²⁾Tanabe Seiyaku Co., Ltd.
*³³⁾DSM Nutrition Japan K.K.
*³⁴⁾DSM Nutrition Japan K.K.
*³⁵⁾DSM Nutrition Japan K.K.
*³⁶⁾OMNICA Co., Ltd.
*³⁷⁾OMNICA Co., Ltd.

TABLE 13

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.14 | 6.97 | +318 |
| only | | | | | |
| +Brown seaweed | 100 mg | 9.0 | 0.32 | 6.98 | −436 |
| powder*³⁸⁾ | | | | | |
| +Aspartame*³⁹⁾ | 20 mg | 9.0 | 0.29 | 6.56 | −193 |
| +Angelica keiskei | 100 mg | 9.0 | 0.42 | 6.71 | −472 |
| powder*⁴⁰⁾ | | | | | |
| +Angelica keiskei | 100 mg | 9.0 | 0.53 | 6.64 | −555 |
| powder*⁴⁰⁾ | | | | | |
| +Dextrin*⁴¹⁾ | 50 mg | | | | |
| +Barley grass | 100 mg | 9.0 | 0.38 | 6.76 | −444 |
| powder*⁴²⁾ | | | | | |
| +Gingembre | 100 mg | 9.0 | 0.36 | 6.53 | −523 |
| powder*⁴³⁾ | | | | | |

*³⁸⁾RIKEN VITAMIN CO., LTD.
*³⁹⁾Ajinomoto Co., Inc.
*⁴⁰⁾Shefco Co., Ltd.
*⁴¹⁾Chugai Chemical Industrial Co., Ltd.
*⁴²⁾Shefco Co., Ltd.
*⁴³⁾MAE CHU CO., LTD

TABLE 14

| | Blending | Time | Dissolved | | Oxidation- |
|---|---|---|---|---|---|
| | amount of | left | hydrogen | | reduction |
| | functional | standing | concentra- | | potential |
| | ingredient | (hours) | tion (ppm) | pH | (mV) |
| Hydrogen water | — | 9.0 | 0.23 | 6.90 | −65 |
| only | | | | | |
| +Polydextrose*⁴⁴⁾ | 1000 mg | 9.0 | 0.40 | 6.94 | −589 |

*⁴⁴⁾Danisco Japan Ltd., trade name: Litesse (registered trademark) III syrup (average molecular weight: 2000)

As listed in Table 3 to Table 14, the result was that the hydrogen-containing drink according to the present invention maintained low oxidation-reduction potentials after the lapse of time by functional ingredients being added to the hydrogen water produced using the process for dissolving hydrogen through a membrane.

1. A hydrogen-containing drink wherein at least one functional ingredient selected from the group consisting of teas; fruits, vegetables, and plants; sugars and sweeteners; polyphenols; vitamins and coenzymes; amino acids and proteins; oxidoreductases; citric acids; and yeast extracts and polydextroses is blended in hydrogen water, the hydrogen-containing drink being prepared by:
degassing water as a raw material, dissolving hydrogen gas in the degassed water through a gas-permeable hollow fiber membrane so as to produce hydrogen water, and dissolving or mixing the functional ingredient in the produced hydrogen water, or
dissolving or mixing the functional ingredient in water as a raw material, degassing the obtained solution or mixture, and dissolving hydrogen gas in the degassed solution or mixture through a gas-permeable hollow fiber membrane.

2. The hydrogen-containing drink according to claim 1, wherein the prepared hydrogen-containing drink is sterilized and disinfected.

3. The hydrogen-containing drink according to claim 1, wherein water as a raw material or water in which a functional ingredient is mixed or dissolved is filtered and/or purified before degassed.

4. The hydrogen-containing drink according to claim 1, the hydrogen-containing drink including two or more of the functional ingredients.

5. The hydrogen-containing drink according to claim 1, wherein the teas are powder or extract of tea selected from the group consisting of green tea (Sencha, Matcha), brown rice tea, Hojicha, barley tea, black tea, oolong tea, du zhong tea, seaweed drink, pu-erh tea, Rooibos tea, sweet tea, and senna tea.

6. The hydrogen-containing drink according to claim 1, wherein the fruits, vegetables, and plants are powder, juice (squeezed liquid), or extract of fruits, vegetables, and plants selected from the group consisting of apple, orange, camu camu, acai, papaya (green papaya), grapefruit, grape, lemon, peach, pineapple, mango, apricot, cherry, melon, japanese apricot, strawberry, blueberry, raspberry, blackberry, cranberry, english gooseberry, cassis (blackcurrant), hilbery, acerola, Lonicera caerulea var. emphyllocalyx, morinda C. (noni), pomegranate, seaberry, olive, tomato, carrot, broccoli, onion, celery, cucumber, asparagus, cabbage, Angelica keiskei, aloe, barley grass, mulberry, kale, beefsteak plant, wheat malt, garlic, gingembre, ginseng, Sesamum indicum, soy, Coix lacryma-jobi var. ma-yuen, brown rice, Natto, Acanthopanax senticosus, Corchorus olitorius, Linum usitatissimum, brown seaweed, laminaria, ginkgo leaf, kuma bamboo grass, rose, Moringa, Peucedanum japonicum, spirulina, Fucus vesiculosus, chlorella, marigold (lutein), nigauri, maca, pseudoginseng, Pueraria mirifica, yacon, turmeric, sunchoke, agaricus, chaga mushroom, Hericium erinaceum, grifola frondosa, Ganoderma lucidum (Leyss. ex. Fr.) Karst, Fomes yucatensis, cauliflower fungus, champignon, cat's claw, garcinia cambogia, rose hip, nikko maple, devil's-claw, alexandrian senna, golden candle, bacopa monniera, giant crape-myrtle, chastetree, ashwagandha, neem, guarana, hercampure, Indian coleus, fenugreek, Handroanthus impetiginosus, Actaea racemosa, feverfew, Hoodia gor-doni, Boswellia serrata, Salacia (Kothalahimbutu), echinacea, pfaffia, saw palmetto, and Hypericum perforatum L.

7. The hydrogen-containing drink according to claim 1, wherein the sugars and sweeteners are sugars and sweeteners selected from the group consisting of monosaccharide consisting of glucose (grape sugar), galactose, mannose, fructose (fruit sugar), ribose, allose, psicose, gulose, xylose, arabinose, lixose, idose, and talose; disaccharide consisting of maltose (fruit sugar), lactose, cellobiose, fructose, palatinose, and sucrose (cane sugar); oligosaccharide; polysaccharide consisting of chitin, chitosan, inulin, starch, cellulose, carrageenan, glycogen, pectin, dextrin, cyclodextrin, xyloglucan, gelatin, hyaluronic acid, and algin acid; natural sweetener consisting of sugar, Wasanbon, brown sugar, soft brown sugar, honey, maple syrup, molasses (syrup: sugar cane, sugar beet, and the like), starch syrup, erythritol, trehalose, maltitol, palatinose, xylitol, sorbitol, licorice extract, sweetleaf, and extract of Siraitia grosvenorii; and artificial sweetener consisting of sucralose, aspartame, and acesulfame potassium.

8. The hydrogen-containing drink according to claim 1, wherein the polyphenols are polyphenols selected from the group consisting of flavonoid selected from the group consisting of catechin, anthocyanin, tannin, Rutin, isoflavone, and Hesperidin; chlorogenic acid (phenol acid); ellagic acid; lignan; curcumin; coumarin; resveratrol; and extract of pine bark.

9. The hydrogen-containing drink according to claim 1, wherein the vitamins and coenzymes are selected from the group consisting of vitamin A; vitamin B group selected from the group consisting of vitamin B1, vitamin B6, vitamin B12, vitamin B2 (riboflavin), niacin (nicotinamide, vitamin B3), and folate (vitamin 9); vitamin C; vitamin D; vitamin E; ubiquinone; ubiquinol; and pyrrolo-quinoline quinone.

10. The hydrogen-containing drink according to claim 1, wherein the amino acids and proteins are selected from the group consisting of valine, leucine, isoleucine, alanine, phenylalanine, glycine, tyrosine, arginine, glutamine, glutamic acid, asparagine, asparagine acid, proline, serine, threonine, lecithin, cysteine, placenta, elastin, propolis, royal jelly, astaxanthin, anserine, sardine peptide, DHA, EPA, alpha-lipoic acid, L-carnitine, ornithine, nucleic acid, glucosamine, chondroitin, fucoidan, fucoxanthin, ceramide, sesamin, chia seed, lycopene, squalene, gaba, L-citrulline, and collagen.

11. The hydrogen-containing drink according to claim 1, the hydrogen-containing drink containing the functional ingredient in a ratio of 0.001% by mass to 20% by mass relative to a total mass of the hydrogen-containing drink.
